(19) United States
(12) Patent Application Publication
(10) Pub. No.: US 2025/0047456 A1
(43) Pub. Date: Feb. 6, 2025

(54) MAPPING TRANSMIT-RECEIVE POINT IDENTIFIERS TO SIMULTANEOUS UPLINK TRANSMISSION COMPONENTS FOR MULTIPLE TRANSMIT-RECEIVE POINTS

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Tao LUO, San Diego, CA (US)

(21) Appl. No.: 18/836,171

(22) PCT Filed: Apr. 18, 2022
(86) PCT No.: PCT/CN2022/087339

§ 371 Date: Aug. 6, 2024

(51) Int. Cl. H04L 5/00; H04L 1/08

(52) U.S. Cl. CPC H04L 5/0094; H04L 1/08; H04L 5/0048

(57) ABSTRACT

Various aspects of the present disclosure generally relate to wireless communication. In some aspects, a user equipment (UE) may receive, from a network node associated with a first transmit-receive point (TRP) identifier (ID) and a second TRP ID, an uplink repetition configuration comprising a first mapping between the first TRP ID and a first uplink repetition component and a second mapping between the second TRP ID and a second uplink repetition component. The UE may transmit a first uplink transmission corresponding to the first TRP ID based at least in part on the first mapping. The UE may transmit a second uplink transmission corresponding to the second TRP ID based at least in part on the second mapping. Numerous other aspects are described.

### FIELD OF THE DISCLOSURE

Aspects of the present disclosure generally relate to wireless communication and to techniques and apparatuses for mapping transmit-receive point identifiers to simultaneous uplink transmission components for multiple transmit-receive points.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a network node associated with a first transmit-receive point (TRP) identifier (ID) and a second TRP ID, an uplink repetition configuration comprising a first mapping between the first TRP ID and a first uplink repetition component and a second mapping between the second TRP ID and a second uplink repetition component. The method may include transmitting a first uplink transmission corresponding to the first TRP ID based at least in part on the first mapping. The method may include transmitting a second uplink transmission corresponding to the second TRP ID based at least in part on the second mapping.

Some aspects described herein relate to a method of wireless communication performed by a network node. The method may include transmitting an uplink repetition configuration comprising a first mapping between a first TRP ID and a first uplink repetition component and a second mapping between a second TRP ID and a second uplink repetition component. The method may include receiving a first uplink transmission corresponding to the first TRP ID based at least in part on the first mapping. The method may include receiving a second uplink transmission corresponding to the second TRP ID based at least in part on the second mapping.

Some aspects described herein relate to a UE for wireless communication. The user equipment may include a memory and one or more processors coupled to the memory. The one or more processors may be configured to receive, from a network node associated with a first TRP ID and a second TRP ID, an uplink repetition configuration comprising a first mapping between the first TRP ID and a first uplink repetition component and a second mapping between the second TRP ID and a second uplink repetition component. The one or more processors may be configured to transmit a first uplink transmission corresponding to the first TRP ID based at least in part on the first mapping. The one or more processors may be configured to transmit a second uplink transmission corresponding to the second TRP ID based at least in part on the second mapping.

Some aspects described herein relate to a network node for wireless communication. The network node may include a memory and one or more processors coupled to the memory. The one or more processors may be configured to transmit an uplink repetition configuration comprising a first mapping between a first TRP ID and a first uplink repetition component and a second mapping between a second TRP ID and a second uplink repetition component. The one or more processors may be configured to receive a first uplink transmission corresponding to the first TRP ID based at least in part on the first mapping. The one or more processors may be configured to receive a second uplink transmission corresponding to the second TRP ID based at least in part on the second mapping.

Some aspects described herein relate to a non-transitory computer-readable medium that stores a set of instructions for wireless communication by a UE. The set of instructions, when executed by one or more processors of the UE, may cause the UE to receive, from a network node associated with a first TRP ID and a second TRP ID, an uplink repetition configuration comprising a first mapping between the first TRP ID and a first uplink repetition component and a second mapping between the second TRP ID and a second uplink repetition component. The set of instructions, when executed by one or more processors of the UE, may cause the UE to transmit a first uplink transmission corresponding to the first TRP ID based at least in part on the first mapping. The set of instructions, when executed by one or more processors of the UE, may cause the UE to transmit a second uplink transmission corresponding to the second TRP ID based at least in part on the second mapping.

Some aspects described herein relate to a non-transitory computer-readable medium that stores a set of instructions for wireless communication by a network node. The set of instructions, when executed by one or more processors of the network node, may cause the network node to transmit an uplink repetition configuration comprising a first mapping between a first TRP ID and a first uplink repetition component and a second mapping between a second TRP ID and a second uplink repetition component. The set of instructions, when executed by one or more processors of the network node, may cause the network node to receive a first uplink transmission corresponding to the first TRP ID based at least in part on the first mapping. The set of instructions, when executed by one or more processors of the network node, may cause the network node to receive a second uplink transmission corresponding to the second TRP ID based at least in part on the second mapping.

Some aspects described herein relate to an apparatus for wireless communication. The apparatus may include means for receiving, from a network node associated with a first TRP ID and a second TRP ID, an uplink repetition configuration comprising a first mapping between the first TRP ID and a first uplink repetition component and a second mapping between the second TRP ID and a second uplink repetition component. The apparatus may include means for transmitting a first uplink transmission corresponding to the first TRP ID based at least in part on the first mapping. The apparatus may include means for transmitting a second uplink transmission corresponding to the second TRP ID based at least in part on the second mapping.

Some aspects described herein relate to an apparatus for wireless communication. The apparatus may include means for transmitting an uplink repetition configuration comprising a first mapping between a first TRP ID and a first uplink repetition component and a second mapping between a second TRP ID and a second uplink repetition component. The apparatus may include means for receiving a first uplink transmission corresponding to the first TRP ID based at least in part on the first mapping. The apparatus may include means for receiving a second uplink transmission corresponding to the second TRP ID based at least in part on the second mapping.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating an example of multi-transmit receive point (TRP) operations, in accordance with the present disclosure.

FIG. 5 is a diagram illustrating an example of multi-TRP operations, in accordance with the present disclosure.

FIG. 6 is a diagram illustrating an example of multi-TRP operations, in accordance with the present disclosure.

FIG. 7 is a diagram illustrating an example associated with mapping TRP identifiers (IDs) to simultaneous uplink transmission components for multiple TRPs, in accordance with the present disclosure.

FIGS. 8 and 9 are diagrams illustrating examples associated with mapping TRP IDs to simultaneous uplink transmission components for multiple TRPs, in accordance with the present disclosure.

FIGS. 10 and 11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

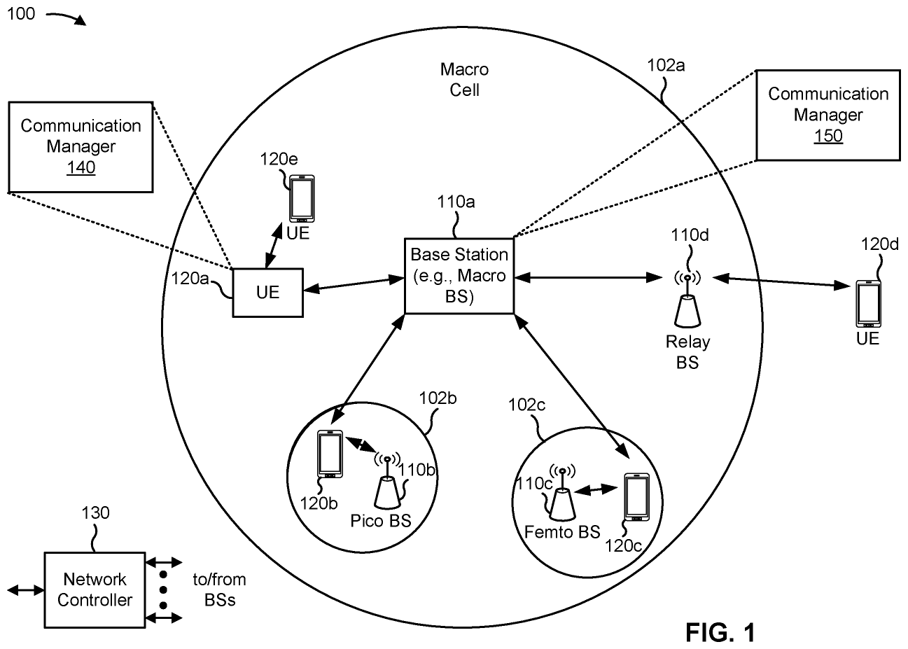

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As described herein, a network node, which also may be referred to as a “node” or a “wireless node,” may be a base station (e.g., base station 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. A network node may be an aggregated base station and/or one or more components of a disaggregated base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

In some aspects, the UE 120 may include a communication manager 140. As described in more detail elsewhere herein, the communication manager 140 may receive, from a network node associated with a first TRP identifier (ID) and a second TRP ID, an uplink repetition configuration comprising a first mapping between the first TRP ID and a first uplink repetition component and a second mapping between the second TRP ID and a second uplink repetition component; transmit a first uplink transmission corresponding to the first TRP ID based at least in part on the first mapping; and transmit a second uplink transmission corresponding to the second TRP ID based at least in part on the second mapping. Additionally, or alternatively, the communication manager 140 may perform one or more other operations described herein.

In some aspects, a network node may include a communication manager 150. As described in more detail elsewhere herein, the communication manager 150 may transmit an uplink repetition configuration comprising a first mapping between a first TRP ID and a first uplink repetition component and a second mapping between a second TRP ID and a second uplink repetition component; receive a first uplink transmission corresponding to the first TRP ID based at least in part on the first mapping; and receive a second uplink transmission corresponding to the second TRP ID based at least in part on the second mapping. Additionally, or alternatively, the communication manager 150 may perform one or more other operations described herein.

As indicated above, FIG. 1 is provided as an example. Other examples may differ from what is described with regard to FIG. 1.

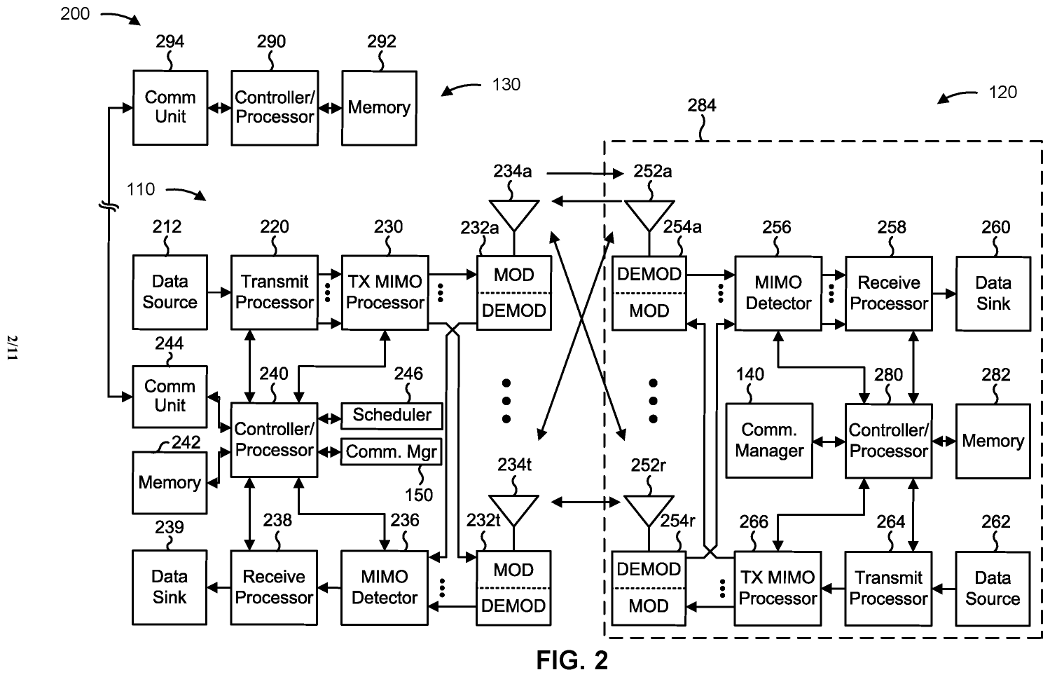

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

In some aspects, the term “base station” (e.g., the base station 110), “network node,” or “network entity” may refer to an aggregated base station, a disaggregated base station, an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of transmission configuration indicator (TCI) states that respectively indicate beams that may be used by the UE, such as for receiving a physical downlink shared channel (PDSCH). The base station may indicate an activated TCI state to the UE, which the UE may use to select a beam for receiving the PDSCH.

A beam indication may be, or include, a TCI state information element, a beam ID, spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qel-Type2, qcl-TypeA, qcl-TypeB, qcl-TypeC, qcl-Type1), and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI. Wireless communications systems may support the use of various types of unified TCIs. For instance, a first type of unified TCI (e.g., Type 1 TCI) may be used to indicate a common beam for at least one downlink channel or reference signal and for at least one uplink channel or reference signal (e.g., a joint downlink uplink common TCI state). A second type of unified TCI (e.g., Type 2 TCI) may be used to indicate a common beam for more than one downlink channel or reference signal (e.g., a separate downlink common TCI state). A third type of unified TCI (e.g., Type 3 TCI) may be used to indicate a common beam for more than one uplink channel or reference signal (e.g., a separate uplink common TCI state). A fourth type of unified TCI (e.g., Type 4 TCI) may be used to indicate a beam for a single downlink channel or reference signal (e.g., a separate downlink single channel or reference signal TCI). A fifth type of unified TCI (e.g., Type 5 TCI) may be used to indicate a beam for a single uplink channel or reference signal (e.g., a separate uplink single channel or reference signal TCI). A sixth type of unified TCI (e.g., Type 6 TCI) may include uplink spatial relation information to indicate a beam for a single uplink channel or reference signal.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

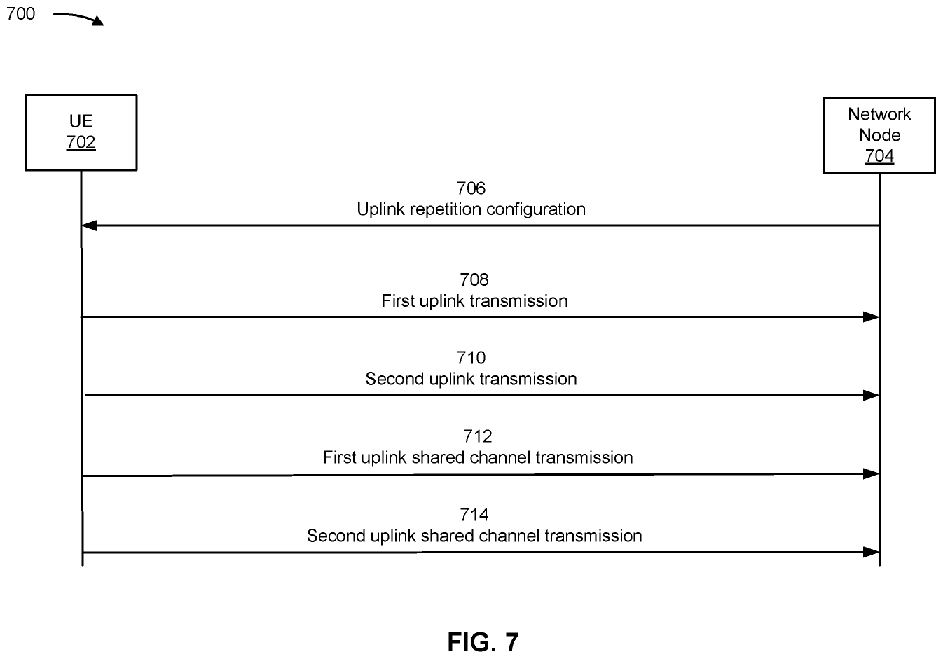

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-11).

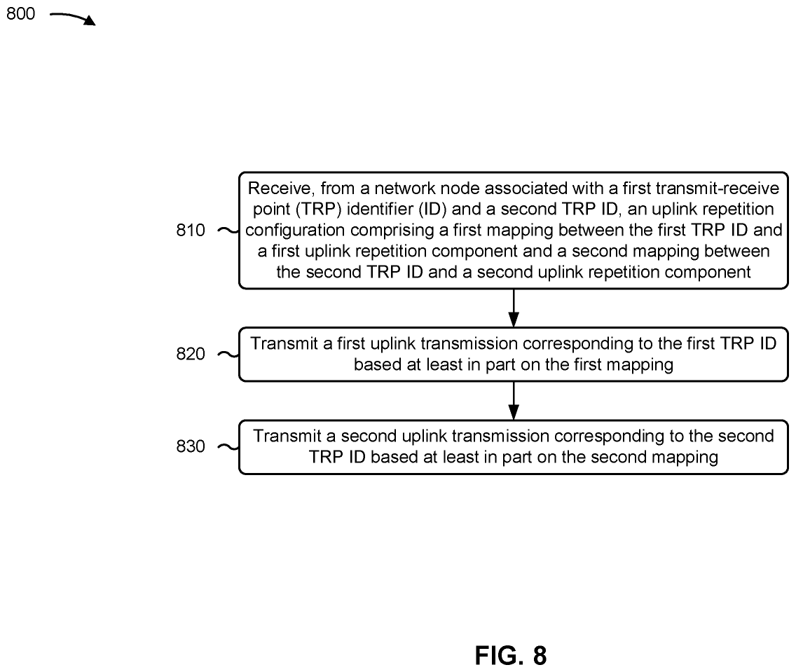

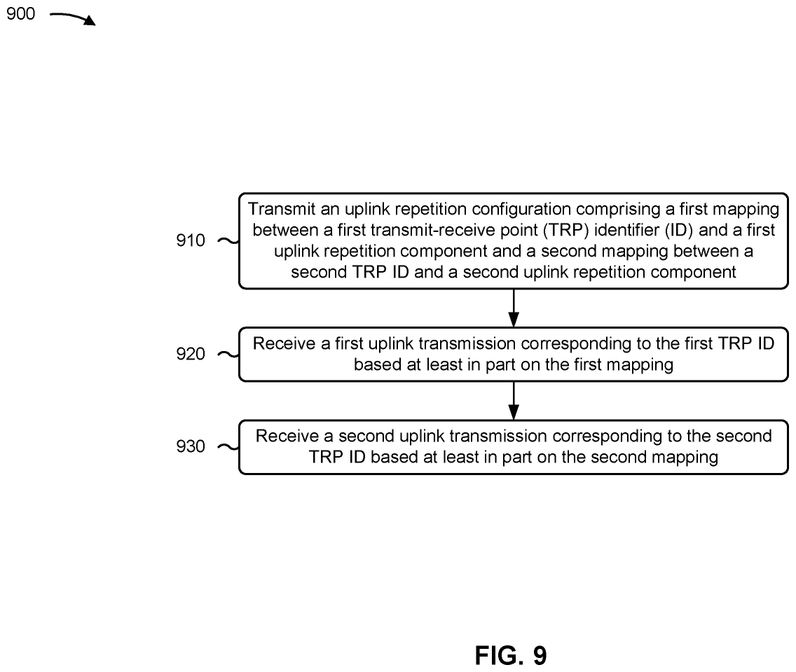

The controller/processor 240 of the base station 110, the controller/processor 280 of the UE 120, and/or any other component(s) of FIG. 2 may perform one or more techniques associated with mapping TRP IDs to simultaneous uplink transmission components for multiple TRPs, as described in more detail elsewhere herein. In some aspects, the network node described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE includes means for receiving, from a network node associated with a first TRP ID and a second TRP ID, an uplink repetition configuration comprising a first mapping between the first TRP ID and a first uplink repetition component and a second mapping between the second TRP ID and a second uplink repetition component; means for transmitting a first uplink transmission corresponding to the first TRP ID based at least in part on the first mapping; and/or means for transmitting a second uplink transmission corresponding to the second TRP ID based at least in part on the second mapping. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node includes means for transmitting an uplink repetition configuration comprising a first mapping between a first TRP ID and a first uplink repetition component and a second mapping between a second TRP ID and a second uplink repetition component; means for receiving a first uplink transmission corresponding to the first TRP ID based at least in part on the first mapping; and/or means for receiving a second uplink transmission corresponding to the second TRP ID based at least in part on the second mapping. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

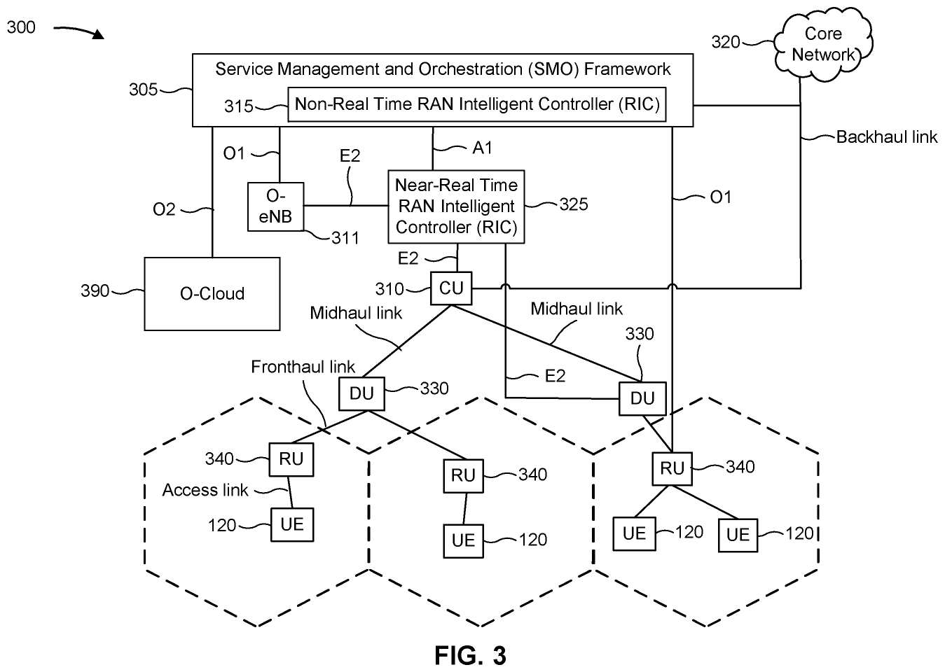

FIG. 3 is a diagram illustrating an example 300 of a disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more RF access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

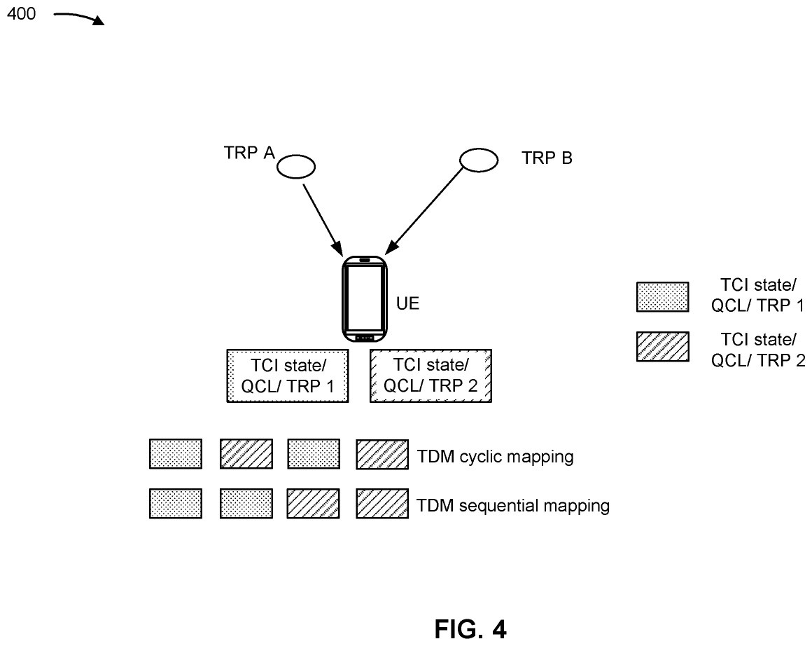

FIG. 4 is a diagram illustrating an example 400 of multi-TRP operations, in accordance with the present disclosure.

As shown in FIG. 4, in a multi-TRP operation, a UE may communicate with a first TRP (TRP A) and a second TRP (TRP B). The first TRP may be associated with a first TCI state or a first QCL. The second TRP may be associated with a second TCI state or a second QCL. The UE may perform uplink transmissions to the first TRP and the second TRP using time division multiplexing (TDM). The UE may perform uplink transmissions to the first TRP and the second TRP using TDM cyclic mapping, in which the UE may alternative between performing uplink transmissions to the first TRP and the second TRP. For example, the UE may perform a first uplink transmission to the first TRP, a second uplink transmission to the second TRP, a third uplink transmission to the first TRP, and a fourth uplink transmission to the second TRP. The UE may perform uplink transmissions to the first TRP and the second TRP using TDM sequential mapping, in which the UE may first perform a set of uplink transmissions to the first TRP and then perform a set of uplink transmissions to the second TRP. For example, the UE may perform a first uplink transmission and a second uplink transmission to the first TRP, and then the UE may perform a third uplink transmission and a fourth uplink transmission to the second TRP.

As indicated above, FIG. 4 is provided as an example. Other examples may differ from what is described with regard to FIG. 4.

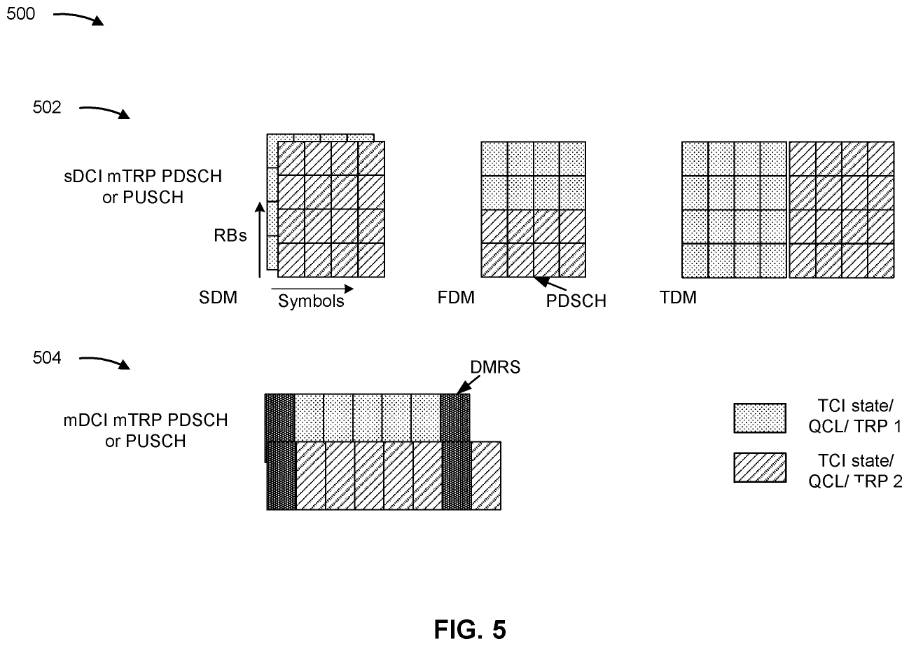

FIG. 5 is a diagram illustrating an example 500 of multi-TRP operations, in accordance with the present disclosure.

As shown by reference number 502, in a multi-TRP operation, a UE may support a single DCI multi-TRP PDSCH transmission or physical uplink shared channel (PUSCH) transmission. In a first example, a first transmission associated with a first TRP (e.g., first TCI state or first QCL) may be spatial division multiplexed (SDM) with a second transmission associated with a second TRP (e.g., second TCI state or second QCL). The first transmission and the second transmission may be associated with different spatial layers but may overlap in time and/or frequency. In a second example, the first transmission may be frequency division multiplexed (FDM) with the second transmission. The first transmission and the second transmission may be simultaneous transmissions and may overlap in time but not in frequency. In a third example, the first transmission may be TDM with the second transmission. The first transmission and the second transmission may be non-simultaneous transmissions. The first transmission and the second transmission may overlap in frequency but not in time.

As shown by reference number 504, in the multi-TRP operation, a UE may support a multiple DCI (multi-DCI) multiple TRP (multi-TRP) PDSCH transmission or PUSCH transmission. A first transmission associated with a first TRP may be frequency division multiplexed with a second transmission associated with a second TRP. The first transmission and the second transmission may be associated with separate DMRSs.

As indicated above, FIG. 5 is provided as an example. Other examples may differ from what is described with regard to FIG. 5.

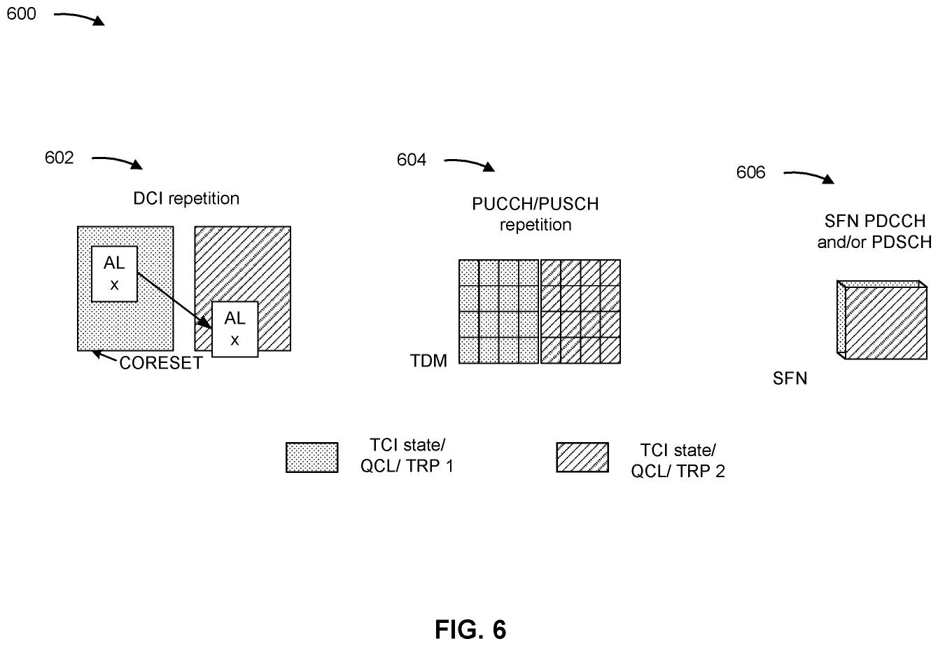

FIG. 6 is a diagram illustrating an example 600 of multi-TRP operations, in accordance with the present disclosure.

As shown by reference number 602, in a multi-TRP operation, a UE may support a DCI repetition. The UE may communicate with a first TRP and a second TRP, where the first TRP may be associated with a first control resource set (CORESET) and/or an aggregation level (AL), and the second TRP may be associated with a second CORESET and/or the AL. As shown by reference number 604, in the multi-TRP operation, the UE may support a physical uplink control channel (PUCCH) or PUSCH repetition, which may be based at least in part on TDM. As shown by reference number 606, in the multi-TRP operation, the UE may support a single-frequency network (SFN) physical downlink control channel (PDCCH) transmission and/or PDSCH transmission, which may be associated with same time/frequency resources (or same layers) but different beams.

As indicated above, FIG. 6 is provided as an example. Other examples may differ from what is described with regard to FIG. 6.

In some cases, a unified TCI can be extended to multi-TRP (mTRP) scenarios, which can include simultaneous uplink transmissions. Simultaneous uplink transmissions are two or more uplink transmissions that occur simultaneously or during at least partially overlapping respective time periods.

In some cases, a wireless communication standard can specify TDM based PUSCH repetition with beam sweeping across repetitions (which may include a nominal repetition such as, for example, in a PUSCH repetition Type B). The mapping of each SRS resource indicator (SRI) and corresponding uplink beam to each repetition can be determined based on the associated SRS resource set per repetition, when two SRS resource sets are configured. For example, in a first case, the mapping can be defined for PUSCH repetition TypeA and TypeB scheduled and/or activated by DCI. In the first case, if an SRS resource set indicator in a downlink control information (DCI) scheduling a PUSCH is 00, the first SRS resource set of a plurality of configured SRS resource sets is associated with all repetitions of the PUSCH, where the precoder for the PUSCH is derived based on the first SRS resource set. If the SRS resource set indicator in a DCI scheduling the PUSCH is 01, the second SRS resource set of the plurality of SRS resource sets is associated with all repetitions of the PUSCH, where the precoder for PUSCH is derived based on the second SRS resource set. If the SRS resource set indicator in a DCI scheduling the PUSCH is 10 and, if the repetition number is 2, the first and second SRS resources sets are associated with a first and second repetitions of the PUSCH, respectively, where the precoders for the first and second repetitions of PUSCH are derived based on the first and the second SRS resource sets, respectively. If the SRS resource set indicator in a DCI scheduling the PUSCH is 10 and, if the repetition number is greater than 2, then, if high layer parameter cyclicMapping is enabled, the mapping pattern is defined as follows: the first PUSCH repetition is associated with the first SRS resource set, the second PUSCH repetition is associated with the second SRS resource set, the third PUSCH repetition is associated with first SRS resource set, the fourth PUSCH repetition is associated with the second SRS resource set, and so on, and if high layer parameter sequentialMapping is enabled, the mapping pattern is defined as follows: the first PUSCH repetition is associated with the first SRS resource set, the second PUSCH repetition is associated with the first SRS resource set, the third PUSCH repetition is associated with the second SRS resource set, the fourth PUSCH repetition is associated with the second SRS resource set, and so on. If the SRS resource set indicator in a DCI scheduling the PUSCH is 11, the same rule applicable to the situation in which the SRS resource indicator is 10 applies, except that the first SRS resource set and the second SRS resource set are swapped for different PUSCH repetitions.

In a second case, the mapping can be defined for a PUSCH repetition configured by RRC such as, for example, a Type 1 configured grant (CG). In the second case, if a single SRS resource set indicator is provided, the first SRS resource set is associated with all repetitions of the PUSCH. If two SRS resource set indicators are provided, and if repetition the repetition number is 2, the first and second SRS resources sets are associated with first and second repetitions of the PUSCH, respectively. If the repetition number is more than two, and if higher layer parameter cyclicMapping is enabled, the mapping pattern is defined as follows: the first PUSCH repetition is associated with the first SRS resource set, the second PUSCH repetition is associated with the second SRS resource set, the third PUSCH repetition is associated with first SRS resource set, the fourth PUSCH repetition is associated with the second SRS resource set, and so on. If higher layer parameter sequentialMapping is enabled, the mapping pattern is defined as follows: the first PUSCH repetition is associated with the first SRS resource set, the second PUSCH repetition is associated with the first SRS resource set, the third PUSCH repetition is associated with the second SRS resource set, the fourth PUSCH repetition is associated with the second SRS resource set, and so on.

In some cases, TDM based PUCCH repetition with beam sweeping across repetitions is supported. In those cases, when a single PUCCH resource is used for repetitions with two beams, for example, two configured spatial filter settings, if the repetition number is 2, first and second spatial settings are associated with a first and second repetition, respectively. If repetition the repetition number is more than 2, and if cyclicMapping is enabled, the mapping pattern is defined as follows: the first PUCCH repetition is associated with the first beam, the second PUCCH repetition is associated with the second beam, the third PUCCH repetition is associated with the first beam, the fourth PUCCH repetition is associated with the second beam, and so on. Otherwise, the mapping pattern is defined as follows: the first PUCCH repetition is associated with the first beam, the second PUCCH repetition is associated with the first beam, the third PUCCH repetition is associated with the second beam, the fourth PUCCH repetition is associated with the second beam, and so on.

The mapping described above can be useful in single TRP and mTRP settings to facilitate mapping of SRS resources to different beams. In some cases, however, unified TCI per TRP is not mapped to each uplink repetition of a plurality of FDMed and/or SDMed repetitions. Thus, UEs using the mapping described above can be restricted to non-simultaneous uplink transmissions in mTRP scenarios, reducing potential network and resource efficiency.

Some aspects of the techniques and apparatuses described herein may facilitate simultaneous uplink transmissions to two or more TRPs. Although described in terms of simultaneous uplink transmissions to two TRPs, some aspects described herein may equally apply to three or more TRPs. In some aspects, a UE may receive, from a network node associated with a first TRP ID and a second TRP ID, an uplink repetition configuration comprising a first mapping between the first TRP ID and a first uplink repetition component and a second mapping between the second TRP ID and a second uplink repetition component. The UE may transmit a first uplink transmission corresponding to the first TRP ID based at least in part on the first mapping and a second uplink transmission corresponding to the second TRP ID based at least in part on the second mapping. In this way, some aspects may facilitate simultaneous uplink transmissions associated with two or more TRP IDs, thereby increasing network and/or resource efficiency and, as a result, positively impacting network and/or device performance.

FIG. 7 is a diagram illustrating an example 700 associated with mapping transmit-receive point identifiers to simultaneous uplink transmission components for multiple transmit-receive points, in accordance with the present disclosure. As shown in FIG. 7, example 700 includes wireless communication between a UE 702 and a network node 704. The network node 704 may be, include, or be included in, a plurality of TRPs. For example, in some aspects, a first TRP ID and a second TRP ID may be associated with the network node 704. In some aspects, the network node 704 may represent a plurality of network nodes, each of which has an associated TRP ID.

As shown by reference number 706, the network node 704 may transmit, and the UE 702 may receive, an uplink repetition configuration. The uplink repetition configuration may include a first mapping between the first SRS resource set and a first uplink repetition component and a second mapping between the second SRS resource set and a second uplink repetition component. The first mapping may be based at least in part on a mapping between a first SRS resource set and the first uplink repetition component, and the second mapping may be based at least in part on a mapping between a second SRS resource set and the second uplink repetition component. In some aspects, the first mapping may correspond to an association between a first precoding indication by a first transmit precoding matrix index (TPMI) indication and/or a first SRI corresponding to the first SRS resource set and the first uplink repetition component. The second mapping may correspond to an association between a second TPMI indication and/or a second SRI corresponding to the second SRS resource set and the second uplink repetition component.

In some aspects, the first mapping may be further based at least in part on a mapping between the first TRP ID and the first SRS resource set, and the second mapping may be based at least in part on a mapping between the second TRP ID and the second SRS resource set. For example, the first mapping may correspond to an association between a first TCI state associated with the first TRP ID and the first uplink repetition component, and the second mapping may correspond to an association between a second TCI state associated with the second TRP ID and the second uplink repetition component. The first and second TCI states may be a pair of uplink applicable TCI states in a TCI codepoint indicated by a DCI or activated by a MAC-CE. The uplink applicable TCI state may be a uplink TCI, or a joint TCI. In some aspects, the first TRP ID may include at least one of a first CORESET pool index, a first TCI state, a first beam group ID, a first channel, a first reference signal, a first resource group ID, or a first TCI order index, and wherein the second TRP ID comprises at least one of a second CORESET pool index, a second TCI state, a second beam group ID, a second channel, a second reference signal, a second resource group ID, or a second TCI order index.

In some aspects, for example, a mapping between an uplink beam and a corresponding repetition may be based on SRS resource set indicators for simultaneous PUSCH transmission in mTRP scenarios. In some examples, each SRS resource set may be mapped to an FDMed or SDMed PUSCH repetition component. In this way, a TPMI and/or an SRI indication associated with a given SRS resource set may be applied to the corresponding PUSCH repetition component for uplink MIMO precoding determination. Each TRP ID may be mapped to an SRS resource set so that the uplink or joint TCI state associated with a given TRP ID may be applied to the corresponding PUSCH repetition component for uplink beam indication and power control parameters. As indicated above, the TRP ID may be indicated by a CORESETPoolIndex, a TCI group ID, a beam group ID, channel group ID, a reference signal group ID, a resource group ID, and/or the TCI order index among all TCIs mapped to the selected TCI codepoint. For example, a first selected uplink applicable TCI may be mapped to a first TRP, e.g., TRP ID=1, while a second selected uplink applicable TCI may be mapped to a second TRP, e.g., TRP ID=2, where the order index of the two selected TCIs may be predefined. The first selected uplink applicable TCI and the second selected uplink applicable TCI may correspond to a pair of TCIs in a TCI codepoint by certain beam indication signaling, such as a DCI.

In some aspects, the mapping of each SRS resource set to each FDMed or SDMed uplink repetition may be based on an SRS resource set indicator, as described below, with respect to three different cases (referred to, respectively, as “case 1,” “case 2,” and “case 3”). In some aspects, operation parameters (e.g. TPMI, TCI, and/or power control, among other examples) for each uplink repetition may be determined by an SRI and a TRP ID indication associated with the corresponding SRS resource set, as described above.
In case 1, the repetition configuration corresponds to SDM based uplink shared channel (e.g., PUSCH) simultaneous transmissions scheduled and/or activated by DCI. For example, the DCI may schedule an mTRP PUSCH transmission with two DMRS code division multiplexing (CDM) groups that may be indicated in the scheduling DCI. The first uplink repetition component refers to the PUSCH repetition using the first DMRS CDM group indicated by the antenna port indication for DMRS in DCI, and the second uplink repetition component refers to the PUSCH repetition using the second DMRS CDM group indicated by the antenna port indication for DMRS in DCI. The first uplink repetition component and the second uplink repetition component may be transmitted in different sets of spatial layers. In some aspects, the DCI may include an SRS resource set indicator having a value, of a plurality of values, that indicates a mapping between at least one SRS resource set and at least one of the first uplink repetition component or the second uplink repetition component. A first SRS resource set may be associated with the first uplink repetition component and the second uplink repetition component based at least in part on the value of SRS resource set indicator being a first value (e.g., 00) of the plurality of values. A second SRS resource set may be associated with the first uplink repetition component and the second uplink repetition component based at least in part on the value of SRS resource set indicator being a second value (e.g., 01) of the plurality of values. A first SRS resource set may be associated with the first uplink repetition component and a second SRS resource set may be associated with the second uplink repetition component based at least in part on the value of SRS resource set indicator being a third value (e.g., 10) of the plurality of values. A first SRS resource set may be associated with the second uplink repetition component and a second SRS resource set may be associated with the first uplink repetition component based at least in part on the value of SRS resource set indicator being a fourth value (e.g., 11) of the plurality of values. For example, if the SRS resource set indicator has the fourth value, the SRS resource set mapping may be similar to the SRS resource set mapping associated with the third value, but where the first and second SRS resource sets are swapped when associating different uplink repetition components.
In case 2, the repetition configuration may correspond to FDM based uplink shared channel (e.g., PUSCH) simultaneous transmissions scheduled and/or activated by DCI. The DCI may be, for example, a single DCI scheduling mTRP FDM based PUSCH transmissions in which one DMRS CDM group is indicated in the scheduling DCI. The scheduling DCI may allocate a plurality of resource blocks for the scheduled FDM based mTRP PUSCH transmission. In some aspects, the mapping between two uplink repetition components and the two frequency allocations may be defined. In some aspects, the first frequency allocation may correspond to a first half of a plurality of allocated resource blocks, and the second frequency allocation may correspond to a second half of the plurality of allocated resource blocks. In some aspects, the first half of the plurality of resource blocks may be associated with a first codeword using a first redundancy version corresponding to a transport block, and the second half of the plurality of resource blocks may be associated with a second codeword using a second redundancy version corresponding to the transport block. In some aspects, the first and second codewords may be the same, while in some other aspects, the first and second codewords may be different codewords. In some aspects, the first half of the plurality of resource blocks may include a set of resource blocks with even-numbered resource block IDs or with even-numbered resource block group IDs, and the second half of the plurality of resource blocks may include a set of resource blocks with odd-numbered resource block IDs, or with odd-numbered resource block group IDs. In some aspects, the DCI may indicate a frequency allocation mapping. For example, in some aspects, the network node 704 may explicitly or implicitly indicate which mapping to apply. The first uplink repetition component refers to the PUSCH repetition using the first frequency allocation, and the second uplink repetition component refers to the PUSCH repetition using the second frequency allocation. Any number of different parameter values of different parameters may be used as an implicit indication. The mapping of each SRS resource set to each uplink component may be based on the SRS resource set indicator, as with case 1, described above.
In case 3, the repetition configuration may correspond to SDM or FDM based uplink shared channel simultaneous transmissions configured by RRC signaling (e.g., Type-1 CG transmissions). In some aspects, for example, a first SRS resource set of a plurality of SRS resource sets may be associated with the first uplink repetition component and the second uplink repetition component based at least in part on the single SRI indication in the RRC signaling. In some aspects, a first SRS resource set of a plurality of SRS resource sets may be associated with the first uplink repetition component and a second SRS resource set of the plurality of SRS resource sets based at least in part on a first SRI indication associated with the first SRS resource set and a second SRI indication associated with the second SRS resource set in the RRC signaling.

In some aspects, instead of mapping TRP IDs to SRS resource sets, the repetition configuration may map the TRP IDs, and hence corresponding uplink or joint TCI states, directly to each corresponding PUSCH repetition component in SDM or FDM based PUSCH simultaneous transmission. For example, the first TRP ID and the second TRP ID may be mapped to the first and second uplink applicable TCIs, and the first and second uplink applicable TCIs may be mapped to the first and second PUSCH repetition components, respectively, in cases 1, 2, and 3 described above. For example, the first and second SRS resource sets may be replaced by the first and second TRP IDs, respectively, in cases 1, 2, and 3 described above, where the SRS resource set indicator may be reused or replaced by a new field (e.g. a TRP and/or TCI set ID), to indicate whether a single uplink beam or two uplink beams are to be applied. The first uplink applicable TCI and the second uplink applicable TCI may correspond to a pair of TCIs in a TCI codepoint by certain beam indication signaling, such as a DCI.

In some aspects, for example, the first mapping may include a direct mapping between the first TRP ID and the first uplink repetition component, and the second mapping may include a direct mapping between the second TRP ID and the second uplink repetition component. In some aspects, a beam indicator may indicate a number of uplink beams associated with the first uplink repetition component and the second uplink repetition component. In some aspects, the first uplink transmission and the second uplink transmission may be TDMed.

As shown by reference number 708, the UE 702 may transmit, and the network node 704 (e.g., a first TRP associated with the network node 704) may receive, a first uplink transmission corresponding to the first TRP ID based at least in part on the first mapping. As shown by reference number 710, the UE 702 may transmit, and the network node 704 (e.g., a second TRP associated with the network node 704) may receive, a second uplink transmission corresponding to the second TRP ID based at least in part on the second mapping. In some aspects, as described above, the first uplink transmission and the second uplink transmission may be simultaneous uplink transmissions.

In some aspects, the repetition configuration may correspond to SDM or FDM based uplink control channel (e.g., PUCCH) simultaneous transmission, in which the TRP ID, and hence the corresponding uplink or joint TCI state, may be directly mapped to each PUCCH repetition component. The first TCI may be mapped to a first PUCCH repetition component, and the second TCI may be mapped to a second PUCCH repetition component. The first PUCCH repetition component and the second PUCCH repetition component may be multiplexed using at least one of SDM or FDM. In some aspects, the mapping between two PUCCH repetition components and the two frequency allocations of a PUCCH resource may be defined when the first PUCCH repetition component and the second PUCCH repetition component may be multiplexed using FDM. In some aspects, the first frequency allocation may correspond to a first half of a plurality of allocated resource blocks for the PUCCH resource, and the second frequency allocation may correspond to a second half of the plurality of allocated resource blocks of the PUCCH resource. In some other aspects, the first frequency allocation may correspond to a set of odd-numbered resource blocks or resource block groups of a plurality of allocated resource blocks to the PUCCH resource, and the second frequency allocation may correspond to a set of even-numbered resource blocks or resource block groups of a plurality of allocated resource blocks to the PUCCH resource. In some aspects, the first PUCCH repetition component and the second PUCCH repetition component may be mapped to two PUCCH repetitions using the first and second DMRS CDM groups of the PUCCH resource when the first PUCCH repetition component and the second PUCCH repetition component may be multiplexed using SDM.

As shown by reference number 712, the UE 702 may transmit, and the network node 704 may receive, a first uplink shared channel transmission corresponding to a first uplink shared channel component, and as shown by reference number 714, the UE 702 may transmit, and the network node 704 may receive, a second uplink shared channel transmission corresponding to a second uplink shared channel component. In some aspects, the first uplink shared channel component may correspond to a first frequency allocation, and the second uplink shared channel component may correspond to a second frequency allocation that is different from the first frequency allocation.

In some aspects, for example, the first frequency allocation may correspond to a first half of a plurality of resource blocks, and the second frequency allocation may correspond to a second half of the plurality of resource blocks. The first half of the plurality of resource blocks may include a set of resource blocks with even resource block IDs, and the second half of the plurality of resource blocks may include a set of resource blocks with odd resource block IDs. In some aspects, the first uplink shared channel component may correspond to a first CDM group and the second uplink shared channel component may correspond to a second CDM group. In some aspects, the first uplink control channel component may correspond to the first CDM group and the second uplink control channel component may correspond to the second CDM group. The first mapping may correspond to a first rule indicated by a wireless communication standard, and the second mapping may correspond to a second rule indicated by the wireless communication standard.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 702) performs operations associated with mapping TRP IDs to simultaneous uplink transmission components for multiple TRPs.

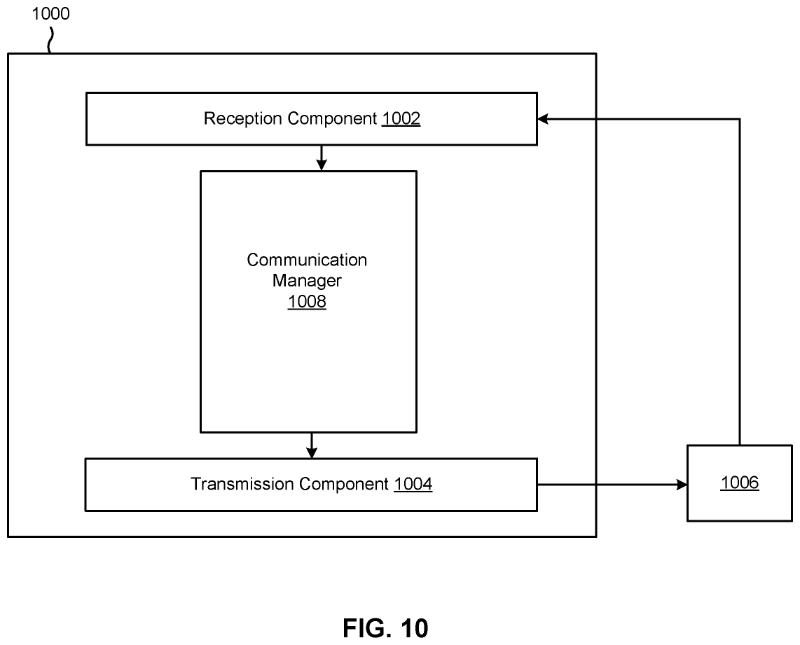

As shown in FIG. 8, in some aspects, process 800 may include receiving, from a network node associated with a first TRP ID and a second TRP ID, an uplink repetition configuration comprising a first mapping between the first TRP ID and a first uplink repetition component and a second mapping between the second TRP ID and a second uplink repetition component (block 810). For example, the UE (e.g., using communication manager 1008 and/or reception component 1002, depicted in FIG. 10) may receive, from a network node associated with a TRP ID and a second TRP ID, an uplink repetition configuration comprising a first mapping between the first TRP ID and a first uplink repetition component and a second mapping between the second TRP ID and a second uplink repetition component, as described above.

As further shown in FIG. 8, in some aspects, process 800 may include transmitting a first uplink transmission corresponding to the first TRP ID based at least in part on the first mapping (block 820). For example, the UE (e.g., using communication manager 1008 and/or transmission component 1004, depicted in FIG. 10) may transmit a first uplink transmission corresponding to the first TRP ID based at least in part on the first mapping, as described above.

As further shown in FIG. 8, in some aspects, process 800 may include transmitting a second uplink transmission corresponding to the second TRP ID based at least in part on the second mapping (block 830). For example, the UE (e.g., using communication manager 1008 and/or transmission component 1004, depicted in FIG. 10) may transmit a second uplink transmission corresponding to the second TRP ID based at least in part on the second mapping, as described above.

Process 800 may include additional aspects, such as any single aspect or any combination of aspects described below and/or in connection with one or more other processes described elsewhere herein.

In a first aspect, the first uplink transmission and the second uplink transmission are simultaneous uplink transmissions. In a second aspect, alone or in combination with the first aspect, the first mapping is based at least in part on a mapping between a first SRS resource set and the first uplink repetition component, and wherein the second mapping is based at least in part on a mapping between a second SRS resource set and the second uplink repetition component. In a third aspect, alone or in combination with the second aspect, the first mapping corresponds to an association between a first TPMI indicated by a first SRI corresponding to the first SRS resource set and the first uplink repetition component, and wherein the second mapping corresponds to an association between a second TPMI indicated by a second SRI corresponding to the second SRS resource set and the second uplink repetition component. In a fourth aspect, alone or in combination with one or more of the second or third aspects, the first mapping is further based at least in part on a mapping between the first TRP ID and the first SRS resource set, and wherein the second mapping is based at least in part on a mapping between the second TRP ID and the second SRS resource set.

In a fifth aspect, alone or in combination with one or more of the first through fourth aspects, the first mapping corresponds to an association between a first TCI state associated with the first TRP ID and the first uplink repetition component, and wherein the second mapping corresponds to an association between a second TCI state associated with the second TRP ID and the second uplink repetition component. In a sixth aspect, alone or in combination with one or more of the first through fifth aspects, the first TRP ID comprises at least one of a first CORESET pool index, a first TCI state, a first beam group ID, a first channel, a first reference signal, a first resource group ID, or a first TCI order index, and wherein the second TRP ID comprises at least one of a second CORESET pool index, a second TCI state, a second beam group ID, a second channel, a second reference signal, a second resource group ID, or a second TCI order index.

In a seventh aspect, alone or in combination with one or more of the first through sixth aspects, process 800 includes receiving DCI indicating a first CDM group associated with the first uplink repetition component and a second CDM group associated with the second uplink repetition component, wherein the first uplink transmission and the second uplink transmission are spatially division multiplexed. In an eighth aspect, alone or in combination with the seventh aspect, the DCI comprises an SRI having an SRI value, of a plurality of values, that indicates a mapping between at least one SRS resource set and at least one of the first uplink repetition component or the second uplink repetition component.

In a ninth aspect, alone or in combination with the eighth aspect, a first SRS resource set is associated with the first uplink repetition component and the second uplink repetition component based at least in part on the SRI value being a first value of the plurality of values. In a tenth aspect, alone or in combination with the eighth aspect, a second SRS resource set is associated with the first uplink repetition component and the second uplink repetition component based at least in part on the SRI value being a second value of the plurality of values. In an eleventh aspect, alone or in combination with the eighth aspect, a first SRS resource set is associated with the first uplink repetition component and a second SRS resource set is associated with the second uplink repetition component based at least in part on the SRI value being a third value of the plurality of values. In a twelfth aspect, alone or in combination with the eighth aspect, a first SRS resource set is associated with the second uplink repetition component and a second SRS resource set is associated with the first uplink repetition component based at least in part on the SRI value being a fourth value of the plurality of values.

In a thirteenth aspect, alone or in combination with one or more of the first through twelfth aspects, process 800 includes receiving DCI indicating a code division multiplexing (CDM) group associated with the first uplink repetition component and the second uplink repetition component, wherein the first uplink transmission and the second uplink transmission are frequency division multiplexed. In a fourteenth aspect, alone or in combination with the thirteenth aspect, the first uplink repetition component corresponds to a first frequency allocation, and wherein the second uplink repetition component corresponds to a second frequency allocation that is different from the first frequency allocation. In a fifteenth aspect, alone or in combination with the fourteenth aspect, the first frequency allocation corresponds to a first half of a plurality of resource blocks, and wherein the second frequency allocation corresponds to a second half of the plurality of resource blocks.

In a sixteenth aspect, alone or in combination with the fifteenth aspect, the first half of the plurality of resource blocks is associated with a first codeword corresponding to a transport block, and wherein the second half of the plurality of resource blocks is associated with a second codeword corresponding to the transport block. In a seventeenth aspect, alone or in combination with the sixteenth aspect, the first codeword is the second codeword. In an eighteenth aspect, alone or in combination with the fifteenth aspect, half of the plurality of resource blocks comprises a set of resource blocks with even resource block IDs, and wherein the second half of the plurality of resource blocks comprises a set of resource blocks with odd resource block IDs.

In a nineteenth aspect, alone or in combination with one or more of the first through eighteenth aspects, the DCI indicates a frequency allocation mapping. In a twentieth aspect, alone or in combination with one or more of the first through nineteenth aspects, process 800 includes receiving an RRC message indicating at least one SRI associated with the first uplink repetition component and the second uplink repetition component, wherein the first uplink transmission and the second uplink transmission are multiplexed based on at least one of frequency division multiplexing or spatial division multiplexing. In a twenty-first aspect, alone or in combination with the twentieth aspect, a first SRS resource set of a plurality of SRS resource sets is associated with the first uplink repetition component and the second uplink repetition component based at least in part on the at least one SRI comprising only one SRI. In a twenty-second aspect, alone or in combination with the twentieth aspect, a first SRS resource set of a plurality of SRS resource sets is associated with the first uplink repetition component and a second SRS resource set of the plurality of SRS resource sets based at least in part on the at least one SRI comprising a first SRI associated with the first SRS resource set and a second SRI associated with the second SRS resource set.

In a twenty-third aspect, alone or in combination with one or more of the first through twenty-second aspects, the first mapping comprises a direct mapping between the first TRP ID and the first uplink repetition component, and wherein the second mapping comprises a direct mapping between the second TRP ID and the second uplink repetition component. In a twenty-fourth aspect, alone or in combination with the twenty-third aspect, a beam indicator indicates a number of uplink beams associated with the first uplink repetition component and the second uplink repetition component. In a twenty-fifth aspect, alone or in combination with one or more of the twenty-third or twenty-fourth aspects, the first uplink transmission and the second uplink transmission are time division multiplexed.

In a twenty-sixth aspect, alone or in combination with one or more of the first through twenty-fifth aspects, the first uplink repetition component comprises a first uplink control channel component and the second uplink repetition component comprises a second uplink control channel component, and wherein the first uplink transmission and the second uplink transmission are multiplexed using at least one of spatial division multiplexing or frequency division multiplexing, the method further comprising transmitting a first uplink shared channel transmission corresponding to a first uplink shared channel component, and transmitting a second uplink shared channel transmission corresponding to a second uplink shared channel component. In a twenty-seventh aspect, alone or in combination with the twenty-sixth aspect, the first uplink shared channel component corresponds to a first frequency allocation, and wherein the second uplink shared channel component corresponds to a second frequency allocation that is different from the first frequency allocation.

In a twenty-eighth aspect, alone or in combination with the twenty-seventh aspect, the first frequency allocation corresponds to a first half of a plurality of resource blocks, and wherein the second frequency allocation corresponds to a second half of the plurality of resource blocks. In a twenty-ninth aspect, alone or in combination with the twenty-eighth aspect, half of the plurality of resource blocks comprises a set of resource blocks with even resource block IDs, and wherein the second half of the plurality of resource blocks comprises a set of resource blocks with odd resource block IDs. In a thirtieth aspect, alone or in combination with one or more of the twenty-sixth through twenty-ninth aspects, the first uplink shared channel component corresponds to a first CDM group and wherein the second uplink shared channel component corresponds to a second CDM group.

In a thirty-first aspect, alone or in combination with the thirtieth aspect, the first uplink control channel component corresponds to the first CDM group and the second uplink control channel component corresponds to the second CDM group. In a thirty-second aspect, alone or in combination with one or more of the thirtieth or thirty-first aspects, the first mapping corresponds to a first rule indicated by a wireless communication standard, and wherein the second mapping corresponds to a second rule indicated by the wireless communication standard.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 704) performs operations associated with mapping TRP IDs to simultaneous uplink transmission components for multiple TRPs.

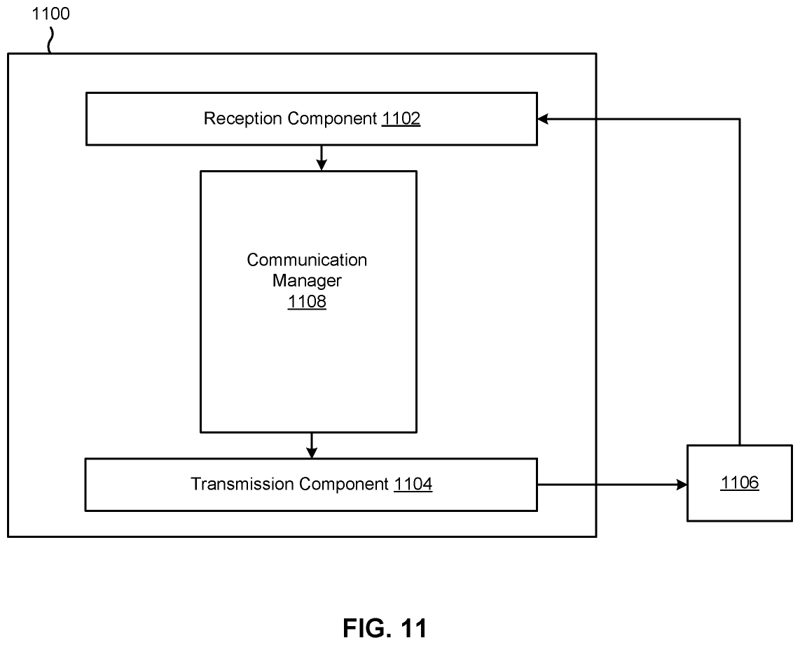

As shown in FIG. 9, in some aspects, process 900 may include transmitting an uplink repetition configuration comprising a first mapping between a first TRP ID and a first uplink repetition component and a second mapping between a second TRP ID and a second uplink repetition component (block 910). For example, the network node (e.g., using communication manager 1108 and/or transmission component 1104, depicted in FIG. 11) may transmit an uplink repetition configuration comprising a first mapping between a first TRP ID and a first uplink repetition component and a second mapping between a second TRP ID and a second uplink repetition component, as described above.

As further shown in FIG. 9, in some aspects, process 900 may include receiving a first uplink transmission corresponding to the first TRP ID based at least in part on the first mapping (block 920). For example, the network node (e.g., using communication manager 1108 and/or reception component 1102, depicted in FIG. 11) may receive a first uplink transmission corresponding to the first TRP ID based at least in part on the first mapping, as described above.

As further shown in FIG. 9, in some aspects, process 900 may include receiving a second uplink transmission corresponding to the second TRP ID based at least in part on the second mapping (block 930). For example, the network node (e.g., using communication manager 1108 and/or reception component 1102, depicted in FIG. 11) may receive a second uplink transmission corresponding to the second TRP ID based at least in part on the second mapping, as described above.

Process 900 may include additional aspects, such as any single aspect or any combination of aspects described below and/or in connection with one or more other processes described elsewhere herein.

In a first aspect, the first uplink transmission and the second uplink transmission are simultaneous uplink transmissions. In a second aspect, alone or in combination with the first aspect, the first mapping is based at least in part on a mapping between a first SRS resource set and the first uplink repetition component, and wherein the second mapping is based at least in part on a mapping between a second SRS resource set and the second uplink repetition component.

In a third aspect, alone or in combination with the second aspect, the first mapping corresponds to an association between a first TPMI indicated by a first SRI corresponding to the first SRS resource set and the first uplink repetition component, and wherein the second mapping corresponds to an association between a second TPMI indicated by a second SRI corresponding to the second SRS resource set and the second uplink repetition component. In a fourth aspect, alone or in combination with one or more of the second or third aspects, the first mapping is further based at least in part on a mapping between the first TRP ID and the first SRS resource set, and wherein the second mapping is based at least in part on a mapping between the second TRP ID and the second SRS resource set.

In a fifth aspect, alone or in combination with one or more of the first through fourth aspects, the first mapping corresponds to an association between a first TCI state associated with the first TRP ID and the first uplink repetition component, and wherein the second mapping corresponds to an association between a second TCI state associated with the second TRP ID and the second uplink repetition component. In a sixth aspect, alone or in combination with one or more of the first through fifth aspects, the first TRP ID comprises at least one of a first CORESET pool index, a first TCI state, a first beam group ID, a first channel, a first reference signal, a first resource group ID, or a first TCI order index, and wherein the second TRP ID comprises at least one of a second CORESET pool index, a second TCI state, a second beam group ID, a second channel, a second reference signal, a second resource group ID, or a second TCI order index.

In a seventh aspect, alone or in combination with one or more of the first through sixth aspects, process 900 includes transmitting DCI indicating a first CDM group associated with the first uplink repetition component and a second CDM group associated with the second uplink repetition component, wherein the first uplink transmission and the second uplink transmission are spatially division multiplexed. In an eighth aspect, alone or in combination with the seventh aspect, the DCI comprises an SRI having an SRI value, of a plurality of values, that indicates a mapping between at least one SRS resource set and at least one of the first uplink repetition component or the second uplink repetition component.

In a ninth aspect, alone or in combination with the seventh aspect, a first SRS resource set is associated with the first uplink repetition component and the second uplink repetition component based at least in part on the SRI value being a first value of the plurality of values. In a tenth aspect, alone or in combination with the seventh aspect, a second SRS resource set is associated with the first uplink repetition component and the second uplink repetition component based at least in part on the SRI value being a second value of the plurality of values. In an eleventh aspect, alone or in combination with the seventh aspect, a first SRS resource set is associated with the first uplink repetition component and a second SRS resource set is associated with the second uplink repetition component based at least in part on the SRI value being a third value of the plurality of values. In a twelfth aspect, alone or in combination with the seventh aspect, a first SRS resource set is associated with the second uplink repetition component and a second SRS resource set is associated with the first uplink repetition component based at least in part on the SRI value being a fourth value of the plurality of values.

In a thirteenth aspect, alone or in combination with one or more of the first through twelfth aspects, process 900 includes transmitting DCI indicating a CDM group associated with the first uplink repetition component and the second uplink repetition component, wherein the first uplink transmission and the second uplink transmission are frequency division multiplexed. In a fourteenth aspect, alone or in combination with the thirteenth aspect, the first uplink repetition component corresponds to a first frequency allocation, and wherein the second uplink repetition component corresponds to a second frequency allocation that is different from the first frequency allocation. In a fifteenth aspect, alone or in combination with the fourteenth aspect, the first frequency allocation corresponds to a first half of a plurality of resource blocks, and wherein the second frequency allocation corresponds to a second half of the plurality of resource blocks.

In a sixteenth aspect, alone or in combination with the fifteenth aspect, the first half of the plurality of resource blocks is associated with a first codeword corresponding to a transport block, and wherein the second half of the plurality of resource blocks is associated with a second codeword corresponding to the transport block. In a seventeenth aspect, alone or in combination with the sixteenth aspect, the first codeword is the second codeword. In an eighteenth aspect, alone or in combination with one or more of the fifteenth through seventeenth aspects, half of the plurality of resource blocks comprises a set of resource blocks with even resource block IDs, and wherein the second half of the plurality of resource blocks comprises a set of resource blocks with odd resource block IDs. In a nineteenth aspect, alone or in combination with one or more of the thirteenth through eighteenth aspects, the DCI indicates a frequency allocation mapping.

In a twentieth aspect, alone or in combination with one or more of the first through nineteenth aspects, process 900 includes transmitting an RRC message indicating at least one SRI associated with the first uplink repetition component and the second uplink repetition component, wherein the first uplink transmission and the second uplink transmission are multiplexed based on at least one of frequency division multiplexing or spatial division multiplexing. In a twenty-first aspect, alone or in combination with the twentieth aspect, a first SRS resource set of a plurality of SRS resource sets is associated with the first uplink repetition component and the second uplink repetition component based at least in part on the at least one SRI comprising only one SRI. In a twenty-second aspect, alone or in combination with the twentieth aspect, a first SRS resource set of a plurality of SRS resource sets is associated with the first uplink repetition component and a second SRS resource set of the plurality of SRS resource sets based at least in part on the at least one SRI comprising a first SRI associated with the first SRS resource set and a second SRI associated with the second SRS resource set.

In a twenty-third aspect, alone or in combination with one or more of the first through twenty-second aspects, the first mapping comprises a direct mapping between the first TRP ID and the first uplink repetition component, and wherein the second mapping comprises a direct mapping between the second TRP ID and the second uplink repetition component. In a twenty-fourth aspect, alone or in combination with the twenty-third aspect, a beam indicator indicates a number of uplink beams associated with the first uplink repetition component and the second uplink repetition component. In a twenty-fifth aspect, alone or in combination with one or more of the twenty-third or twenty-fourth aspects, the first uplink transmission and the second uplink transmission are time division multiplexed.

In a twenty-sixth aspect, alone or in combination with one or more of the first through twenty-fifth aspects, the first uplink repetition component comprises a first uplink control channel component and the second uplink repetition component comprises a second uplink control channel component, and wherein the first uplink transmission and the second uplink transmission are multiplexed using at least one of spatial division multiplexing or frequency division multiplexing, the method further comprising receiving a first uplink shared channel transmission corresponding to a first uplink shared channel component, and receiving a second uplink shared channel transmission corresponding to a second uplink shared channel component. In a twenty-seventh aspect, alone or in combination with the twenty-sixth aspect, the first uplink shared channel component corresponds to a first frequency allocation, and wherein the second uplink shared channel component corresponds to a second frequency allocation that is different from the first frequency allocation. In a twenty-eighth aspect, alone or in combination with the twenty-seventh aspect, the first frequency allocation corresponds to a first half of a plurality of resource blocks, and wherein the second frequency allocation corresponds to a second half of the plurality of resource blocks. In a twenty-ninth aspect, alone or in combination with the twenty-eighth aspect, half of the plurality of resource blocks comprises a set of resource blocks with even resource block IDs, and wherein the second half of the plurality of resource blocks comprises a set of resource blocks with odd resource block IDs.

In a thirtieth aspect, alone or in combination with one or more of the twenty-sixth through twenty-ninth aspects, the first uplink shared channel component corresponds to a first CDM group and wherein the second uplink shared channel component corresponds to a second CDM group. In a thirty-first aspect, alone or in combination with the thirtieth aspect, the first uplink control channel component corresponds to the first CDM group and the second uplink control channel component corresponds to the second CDM group. In a thirty-second aspect, alone or in combination with one or more of the thirtieth or thirty-first aspects, the first mapping corresponds to a first rule indicated by a wireless communication standard, and wherein the second mapping corresponds to a second rule indicated by the wireless communication standard.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 1008.

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The communication manager 1008 and/or the reception component 1002 may receive, from a network node associated with a first TRP ID and a second TRP ID, an uplink repetition configuration comprising a first mapping between the first TRP ID and a first uplink repetition component and a second mapping between the second TRP ID and a second uplink repetition component. In some aspects, the communication manager 1008 may include one or more antennas, a modem, a controller/processor, a memory, or a combination thereof, of the UE described in connection with FIG. 2. In some aspects, the communication manager 1008 may be, be similar to, include, or be included in, the communication manager 140 depicted in FIGS. 1 and 2. In some aspects, the communication manager 1008 may include the reception component 1002 and/or the transmission component 1004.

The communication manager 1008 and/or the transmission component 1004 may transmit a first uplink transmission corresponding to the first TRP ID based at least in part on the first mapping. The communication manager 1008 and/or the transmission component 1004 may transmit a second uplink transmission corresponding to the second TRP ID based at least in part on the second mapping.

The communication manager 1008 and/or the reception component 1002 may receive DCI indicating a first CDM group associated with the first uplink repetition component and a second CDM group associated with the second uplink repetition component, wherein the first uplink transmission and the second uplink transmission are spatially division multiplexed. The communication manager 1008 and/or the reception component 1002 may receive DCI indicating a CDM group associated with the first uplink repetition component and the second uplink repetition component, wherein the first uplink transmission and the second uplink transmission are frequency division multiplexed. The communication manager 1008 and/or the reception component 1002 may receive an RRC message indicating at least one SRI associated with the first uplink repetition component and the second uplink repetition component, wherein the first uplink transmission and the second uplink transmission are multiplexed based on at least one of frequency division multiplexing or spatial division multiplexing.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manager 1108.

In some aspects, the apparatus 1100 may be configured to perform one or more operations described herein in connection with FIG. 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the base station described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the base station described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the base station described in connection with FIG. 2. In some aspects, the transmission component 1104 may be co-located with the reception component 1102 in a transceiver.

The communication manager 1108 and/or the transmission component 1104 may transmit an uplink repetition configuration comprising a first mapping between a first TRP ID and a first uplink repetition component and a second mapping between a second TRP ID and a second uplink repetition component. In some aspects, the communication manager 1108 may include one or more antennas, a modem, a controller/processor, a memory, or a combination thereof, of the base station described in connection with FIG. 2. In some aspects, the communication manager 1108 may be, be similar to, include, or be included in the communication manager 150 depicted in FIGS. 1 and 2. In some aspects, the communication manager 1108 may include the reception component 1102 and/or the transmission component 1104.

The communication manager 1108 and/or the reception component 1102 may receive a first uplink transmission corresponding to the first TRP ID based at least in part on the first mapping. The communication manager 1108 and/or the reception component 1102 may receive a second uplink transmission corresponding to the second TRP ID based at least in part on the second mapping. The communication manager 1108 and/or the transmission component 1104 may transmit DCI indicating a first CDM group associated with the first uplink repetition component and a second CDM group associated with the second uplink repetition component, wherein the first uplink transmission and the second uplink transmission are spatially division multiplexed.

The communication manager 1108 and/or the transmission component 1104 may transmit DCI indicating a CDM group associated with the first uplink repetition component and the second uplink repetition component, wherein the first uplink transmission and the second uplink transmission are frequency division multiplexed.

The communication manager 1108 and/or the transmission component 1104 may transmit an RRC message indicating at least one SRI associated with the first uplink repetition component and the second uplink repetition component, wherein the first uplink transmission and the second uplink transmission are multiplexed based on at least one of frequency division multiplexing or spatial division multiplexing.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: receiving, from a network node associated with a first transmit-receive point (TRP) identifier (ID) and a second TRP ID, an uplink repetition configuration comprising a first mapping between the first TRP ID and a first uplink repetition component and a second mapping between the second TRP ID and a second uplink repetition component; transmitting a first uplink transmission corresponding to the first TRP ID based at least in part on the first mapping; and transmitting a second uplink transmission corresponding to the second TRP ID based at least in part on the second mapping.
Aspect 2: The method of Aspect 1, wherein the first uplink transmission and the second uplink transmission are simultaneous uplink transmissions.
Aspect 3: The method of either of Aspects 1 or 2, wherein the first mapping is based at least in part on a mapping between a first sounding reference signal (SRS) resource set and the first uplink repetition component, and wherein the second mapping is based at least in part on a mapping between a second SRS resource set and the second uplink repetition component.
Aspect 4: The method of Aspect 3, wherein the first mapping corresponds to an association between a first transmit precoding matrix index (TPMI) indicated by a first SRS resource indicator (SRI) corresponding to the first SRS resource set and the first uplink repetition component, and wherein the second mapping corresponds to an association between a second TPMI indicated by a second SRI corresponding to the second SRS resource set and the second uplink repetition component.
Aspect 5: The method of either of Aspects 3 or 4, wherein the first mapping is further based at least in part on a mapping between the first TRP ID and the first SRS resource set, and wherein the second mapping is based at least in part on a mapping between the second TRP ID and the second SRS resource set.
Aspect 6: The method of any of Aspects 1-5, wherein the first mapping corresponds to an association between a first transmission configuration indicator (TCI) state associated with the first TRP ID and the first uplink repetition component, and wherein the second mapping corresponds to an association between a second TCI state associated with the second TRP ID and the second uplink repetition component.
Aspect 7: The method of any of Aspects 1-5, wherein the first TRP ID comprises at least one of a first control resource set (CORESET) pool index, a first transmission configuration indicator (TCI) state, a first beam group ID, a first channel, a first reference signal, a first resource group ID, or a first TCI order index, and wherein the second TRP ID comprises at least one of a second CORESET pool index, a second TCI state, a second beam group ID, a second channel, a second reference signal, a second resource group ID, or a second TCI order index.
Aspect 8: The method of any of Aspects 1-5, further comprising receiving downlink control information (DCI) indicating a first code division multiplexing (CDM) group associated with the first uplink repetition component and a second CDM group associated with the second uplink repetition component, wherein the first uplink transmission and the second uplink transmission are spatially division multiplexed.
Aspect 9: The method of Aspect 8, wherein the DCI comprises a sounding reference signal (SRS) resource indicator (SRI) having an SRI value, of a plurality of values, that indicates a mapping between at least one SRS resource set and at least one of the first uplink repetition component or the second uplink repetition component.
Aspect 10: The method of Aspect 9, wherein a first SRS resource set is associated with the first uplink repetition component and the second uplink repetition component based at least in part on the SRI value being a first value of the plurality of values.
Aspect 11: The method of Aspect 9, wherein a second SRS resource set is associated with the first uplink repetition component and the second uplink repetition component based at least in part on the SRI value being a second value of the plurality of values.
Aspect 12: The method of Aspect 9, wherein a first SRS resource set is associated with the first uplink repetition component and a second SRS resource set is associated with the second uplink repetition component based at least in part on the SRI value being a third value of the plurality of values.
Aspect 13: The method of Aspect 9, wherein a first SRS resource set is associated with the second uplink repetition component and a second SRS resource set is associated with the first uplink repetition component based at least in part on the SRI value being a fourth value of the plurality of values.
Aspect 14: The method of any of Aspects 1-5, further comprising receiving downlink control information (DCI) indicating a code division multiplexing (CDM) group associated with the first uplink repetition component and the second uplink repetition component, wherein the first uplink transmission and the second uplink transmission are frequency division multiplexed.
Aspect 15: The method of Aspect 14, wherein the first uplink repetition component corresponds to a first frequency allocation, and wherein the second uplink repetition component corresponds to a second frequency allocation that is different from the first frequency allocation.
Aspect 16: The method of Aspect 15, wherein the first frequency allocation corresponds to a first half of a plurality of resource blocks, and wherein the second frequency allocation corresponds to a second half of the plurality of resource blocks.
Aspect 17: The method of Aspect 16, wherein the first half of the plurality of resource blocks is associated with a first codeword corresponding to a transport block, and wherein the second half of the plurality of resource blocks is associated with a second codeword corresponding to the transport block.
Aspect 18: The method of Aspect 17, wherein the first codeword is the second codeword.
Aspect 19: The method of Aspect 16, wherein first half of the plurality of resource blocks comprises a set of resource blocks with even resource block IDs, and wherein the second half of the plurality of resource blocks comprises a set of resource blocks with odd resource block IDs.
Aspect 20: The method of any of Aspects 14-19, wherein the DCI indicates a frequency allocation mapping.
Aspect 21: The method of any of Aspects 1-20, further comprising receiving a radio resource control (RRC) message indicating at least one sounding reference signal (SRS) resource indicator (SRI) associated with the first uplink repetition component and the second uplink repetition component, wherein the first uplink transmission and the second uplink transmission are multiplexed based on at least one of frequency division multiplexing or spatial division multiplexing.
Aspect 22: The method of Aspect 21, wherein a first SRS resource set of a plurality of SRS resource sets is associated with the first uplink repetition component and the second uplink repetition component based at least in part on the at least one SRI comprising only one SRI.
Aspect 23: The method of Aspect 21, wherein a first SRS resource set of a plurality of SRS resource sets is associated with the first uplink repetition component and a second SRS resource set of the plurality of SRS resource sets based at least in part on the at least one SRI comprising a first SRI associated with the first SRS resource set and a second SRI associated with the second SRS resource set.
Aspect 24: The method of any of Aspects 1-23, wherein the first mapping comprises a direct mapping between the first TRP ID and the first uplink repetition component, and wherein the second mapping comprises a direct mapping between the second TRP ID and the second uplink repetition component.
Aspect 25: The method of Aspect 24, wherein a beam indicator indicates a number of uplink beams associated with the first uplink repetition component and the second uplink repetition component.
Aspect 26: The method of either of Aspects 24 or 25, wherein the first uplink transmission and the second uplink transmission are time division multiplexed.
Aspect 27: The method of any of Aspects 1-26, wherein the first uplink repetition component comprises a first uplink control channel component and the second uplink repetition component comprises a second uplink control channel component, and wherein the first uplink transmission and the second uplink transmission are multiplexed using at least one of spatial division multiplexing or frequency division multiplexing, the method further comprising: transmitting a first uplink shared channel transmission corresponding to a first uplink shared channel component; and transmitting a second uplink shared channel transmission corresponding to a second uplink shared channel component.
Aspect 28: The method of Aspect 27, wherein the first uplink shared channel component corresponds to a first frequency allocation, and wherein the second uplink shared channel component corresponds to a second frequency allocation that is different from the first frequency allocation.
Aspect 29: The method of Aspect 28, wherein the first frequency allocation corresponds to a first half of a plurality of resource blocks, and wherein the second frequency allocation corresponds to a second half of the plurality of resource blocks.
Aspect 30: The method of Aspect 29, wherein first half of the plurality of resource blocks comprises a set of resource blocks with even resource block IDs, and wherein the second half of the plurality of resource blocks comprises a set of resource blocks with odd resource block IDs.
Aspect 31: The method of any of Aspects 27-30, wherein the first uplink shared channel component corresponds to a first code division multiplexing (CDM) group and wherein the second uplink shared channel component corresponds to a second CDM group.
Aspect 32: The method of Aspect 31, wherein the first uplink control channel component corresponds to the first CDM group and the second uplink control channel component corresponds to the second CDM group.
Aspect 33: The method of either of Aspects 31 or 32, wherein the first mapping corresponds to a first rule indicated by a wireless communication standard, and wherein the second mapping corresponds to a second rule indicated by the wireless communication standard.
Aspect 34: A method of wireless communication performed by a network node, comprising: transmitting an uplink repetition configuration comprising a first mapping between a first transmit-receive point (TRP) identifier (ID) and a first uplink repetition component and a second mapping between a second TRP ID and a second uplink repetition component; receiving a first uplink transmission corresponding to the first TRP ID based at least in part on the first mapping; and receiving a second uplink transmission corresponding to the second TRP ID based at least in part on the second mapping.
Aspect 35: The method of Aspect 34, wherein the first uplink transmission and the second uplink transmission are simultaneous uplink transmissions.
Aspect 36: The method of either of Aspects 34 or 35, wherein the first mapping is based at least in part on a mapping between a first sounding reference signal (SRS) resource set and the first uplink repetition component, and wherein the second mapping is based at least in part on a mapping between a second SRS resource set and the second uplink repetition component.
Aspect 37: The method of Aspect 36, wherein the first mapping corresponds to an association between a first transmit precoding matrix index (TPMI) indicated by a first SRS resource indicator (SRI) corresponding to the first SRS resource set and the first uplink repetition component, and wherein the second mapping corresponds to an association between a second TPMI indicated by a second SRI corresponding to the second SRS resource set and the second uplink repetition component.
Aspect 38: The method of either of Aspects 36 or 37, wherein the first mapping is further based at least in part on a mapping between the first TRP ID and the first SRS resource set, and wherein the second mapping is based at least in part on a mapping between the second TRP ID and the second SRS resource set.
Aspect 39: The method of any of Aspects 34-38, wherein the first mapping corresponds to an association between a first transmission configuration indicator (TCI) state associated with the first TRP ID and the first uplink repetition component, and wherein the second mapping corresponds to an association between a second TCI state associated with the second TRP ID and the second uplink repetition component.
Aspect 40: The method of any of Aspects 34-39, wherein the first TRP ID comprises at least one of a first control resource set (CORESET) pool index, a first transmission configuration indicator (TCI) state, a first beam group ID, a first channel, a first reference signal, a first resource group ID, or a first TCI order index, and wherein the second TRP ID comprises at least one of a second CORESET pool index, a second TCI state, a second beam group ID, a second channel, a second reference signal, a second resource group ID, or a second TCI order index.
Aspect 41: The method of any of Aspects 34-40, further comprising transmitting downlink control information (DCI) indicating a first code division multiplexing (CDM) group associated with the first uplink repetition component and a second CDM group associated with the second uplink repetition component, wherein the first uplink transmission and the second uplink transmission are spatially division multiplexed.
Aspect 42: The method of Aspect 41, wherein the DCI comprises a sounding reference signal (SRS) resource indicator (SRI) having an SRI value, of a plurality of values, that indicates a mapping between at least one SRS resource set and at least one of the first uplink repetition component or the second uplink repetition component.
Aspect 43: The method of Aspect 42, wherein a first SRS resource set is associated with the first uplink repetition component and the second uplink repetition component based at least in part on the SRI value being a first value of the plurality of values.
Aspect 44: The method of Aspect 42, wherein a second SRS resource set is associated with the first uplink repetition component and the second uplink repetition component based at least in part on the SRI value being a second value of the plurality of values.
Aspect 45: The method of Aspect 42, wherein a first SRS resource set is associated with the first uplink repetition component and a second SRS resource set is associated with the second uplink repetition component based at least in part on the SRI value being a third value of the plurality of values.
Aspect 46: The method of Aspect 42, wherein a first SRS resource set is associated with the second uplink repetition component and a second SRS resource set is associated with the first uplink repetition component based at least in part on the SRI value being a fourth value of the plurality of values.
Aspect 47: The method of any of Aspects 34-46, further comprising transmitting downlink control information (DCI) indicating a code division multiplexing (CDM) group associated with the first uplink repetition component and the second uplink repetition component, wherein the first uplink transmission and the second uplink transmission are frequency division multiplexed.
Aspect 48: The method of Aspect 47, wherein the first uplink repetition component corresponds to a first frequency allocation, and wherein the second uplink repetition component corresponds to a second frequency allocation that is different from the first frequency allocation.
Aspect 49: The method of Aspect 48, wherein the first frequency allocation corresponds to a first half of a plurality of resource blocks, and wherein the second frequency allocation corresponds to a second half of the plurality of resource blocks.
Aspect 50: The method of Aspect 49, wherein the first half of the plurality of resource blocks is associated with a first codeword corresponding to a transport block, and wherein the second half of the plurality of resource blocks is associated with a second codeword corresponding to the transport block.
Aspect 51: The method of Aspect 50, wherein the first codeword is the second codeword.
Aspect 52: The method of any of Aspects 49-51, wherein first half of the plurality of resource blocks comprises a set of resource blocks with even resource block IDs, and wherein the second half of the plurality of resource blocks comprises a set of resource blocks with odd resource block IDs.
Aspect 53: The method of any of Aspects 47-52, wherein the DCI indicates a frequency allocation mapping.
Aspect 54: The method of any of Aspects 34-53, further comprising transmitting a radio resource control (RRC) message indicating at least one sounding reference signal (SRS) resource indicator (SRI) associated with the first uplink repetition component and the second uplink repetition component, wherein the first uplink transmission and the second uplink transmission are multiplexed based on at least one of frequency division multiplexing or spatial division multiplexing.
Aspect 55: The method of Aspect 54, wherein a first SRS resource set of a plurality of SRS resource sets is associated with the first uplink repetition component and the second uplink repetition component based at least in part on the at least one SRI comprising only one SRI.
Aspect 56: The method of Aspect 54, wherein a first SRS resource set of a plurality of SRS resource sets is associated with the first uplink repetition component and a second SRS resource set of the plurality of SRS resource sets based at least in part on the at least one SRI comprising a first SRI associated with the first SRS resource set and a second SRI associated with the second SRS resource set.
Aspect 57: The method of any of Aspects 34-56, wherein the first mapping comprises a direct mapping between the first TRP ID and the first uplink repetition component, and wherein the second mapping comprises a direct mapping between the second TRP ID and the second uplink repetition component.
Aspect 58: The method of Aspect 57, wherein a beam indicator indicates a number of uplink beams associated with the first uplink repetition component and the second uplink repetition component.
Aspect 59: The method of either of Aspects 57 or 58, wherein the first uplink transmission and the second uplink transmission are time division multiplexed.
Aspect 60: The method of any of Aspects 34-59, wherein the first uplink repetition component comprises a first uplink control channel component and the second uplink repetition component comprises a second uplink control channel component, and wherein the first uplink transmission and the second uplink transmission are multiplexed using at least one of spatial division multiplexing or frequency division multiplexing, the method further comprising: receiving a first uplink shared channel transmission corresponding to a first uplink shared channel component; and receiving a second uplink shared channel transmission corresponding to a second uplink shared channel component.
Aspect 61: The method of Aspect 60, wherein the first uplink shared channel component corresponds to a first frequency allocation, and wherein the second uplink shared channel component corresponds to a second frequency allocation that is different from the first frequency allocation.
Aspect 62: The method of Aspect 61, wherein the first frequency allocation corresponds to a first half of a plurality of resource blocks, and wherein the second frequency allocation corresponds to a second half of the plurality of resource blocks.
Aspect 63: The method of Aspect 62, wherein first half of the plurality of resource blocks comprises a set of resource blocks with even resource block IDs, and wherein the second half of the plurality of resource blocks comprises a set of resource blocks with odd resource block IDs.
Aspect 64: The method of any of Aspects 60-63, wherein the first uplink shared channel component corresponds to a first code division multiplexing (CDM) group and wherein the second uplink shared channel component corresponds to a second CDM group.
Aspect 65: The method of Aspect 64, wherein the first uplink control channel component corresponds to the first CDM group and the second uplink control channel component corresponds to the second CDM group.
Aspect 66: The method of either of Aspects 64 or 65, wherein the first mapping corresponds to a first rule indicated by a wireless communication standard, and wherein the second mapping corresponds to a second rule indicated by the wireless communication standard.
Aspect 67: An apparatus for wireless communication at a device, comprising a processor; memory coupled with the processor; and instructions stored in the memory and executable by the processor to cause the apparatus to perform the method of one or more of Aspects 1-33.
Aspect 68: A device for wireless communication, comprising a memory and one or more processors coupled to the memory, the one or more processors configured to perform the method of one or more of Aspects 1-33.
Aspect 69: An apparatus for wireless communication, comprising at least one means for performing the method of one or more of Aspects 1-33.
Aspect 70: A non-transitory computer-readable medium storing code for wireless communication, the code comprising instructions executable by a processor to perform the method of one or more of Aspects 1-33.
Aspect 71: A non-transitory computer-readable medium storing a set of instructions for wireless communication, the set of instructions comprising one or more instructions that, when executed by one or more processors of a device, cause the device to perform the method of one or more of Aspects 1-33.
Aspect 72: An apparatus for wireless communication at a device, comprising a processor; memory coupled with the processor; and instructions stored in the memory and executable by the processor to cause the apparatus to perform the method of one or more of Aspects 34-66.
Aspect 73: A device for wireless communication, comprising a memory and one or more processors coupled to the memory, the one or more processors configured to perform the method of one or more of Aspects 34-66.
Aspect 74: An apparatus for wireless communication, comprising at least one means for performing the method of one or more of Aspects 34-66.
Aspect 75: A non-transitory computer-readable medium storing code for wireless communication, the code comprising instructions executable by a processor to perform the method of one or more of Aspects 34-66.
Aspect 76: A non-transitory computer-readable medium storing a set of instructions for wireless communication, the set of instructions comprising one or more instructions that, when executed by one or more processors of a device, cause the device to perform the method of one or more of Aspects 34-66.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a network node associated with a first transmit-receive point (TRP) identifier (ID) and a second TRP ID, an uplink repetition configuration comprising a first mapping between the first TRP ID and a first uplink repetition component and a second mapping between the second TRP ID and a second uplink repetition component;
transmit a first uplink transmission corresponding to the first TRP ID based at least in part on the first mapping; and
transmit a second uplink transmission corresponding to the second TRP ID based at least in part on the second mapping.

2. The UE of claim 1, wherein the first uplink transmission and the second uplink transmission are simultaneous uplink transmissions.

3. The UE of claim 1, wherein the first mapping is based at least in part on a mapping between a first sounding reference signal (SRS) resource set and the first uplink repetition component, and wherein the second mapping is based at least in part on a mapping between a second SRS resource set and the second uplink repetition component.

4. The UE of claim 3, wherein the first mapping corresponds to an association between a first transmit precoding matrix index (TPMI) indicated by a first SRS resource indicator (SRI) corresponding to the first SRS resource set and the first uplink repetition component, and wherein the second mapping corresponds to an association between a second TPMI indicated by a second SRI corresponding to the second SRS resource set and the second uplink repetition component.

5. The UE of claim 3, wherein the first mapping is further based at least in part on a mapping between the first TRP ID and the first SRS resource set, and wherein the second mapping is based at least in part on a mapping between the second TRP ID and the second SRS resource set.

6. The UE of claim 1, wherein the first mapping corresponds to an association between a first transmission configuration indicator (TCI) state associated with the first TRP ID and the first uplink repetition component, and wherein the second mapping corresponds to an association between a second TCI state associated with the second TRP ID and the second uplink repetition component.

7. The UE of claim 1, wherein the one or more processors are further configured to receive downlink control information (DCI) indicating a first code division multiplexing (CDM) group associated with the first uplink repetition component and a second CDM group associated with the second uplink repetition component, wherein the first uplink transmission and the second uplink transmission are spatially division multiplexed.

8. The UE of claim 7, wherein the DCI comprises a sounding reference signal (SRS) resource indicator (SRI) having an SRI value, of a plurality of values, that indicates a mapping between at least one SRS resource set and at least one of the first uplink repetition component or the second uplink repetition component, and
wherein a first SRS resource set is associated with the first uplink repetition component and the second uplink repetition component based at least in part on the SRI value being a first value of the plurality of values,
wherein a second SRS resource set is associated with the first uplink repetition component and the second uplink repetition component based at least in part on the SRI value being a second value of the plurality of values,
wherein a first SRS resource set is associated with the first uplink repetition component and a second SRS resource set is associated with the second uplink repetition component based at least in part on the SRI value being a third value of the plurality of values, or
wherein a first SRS resource set is associated with the second uplink repetition component and a second SRS resource set is associated with the first uplink repetition component based at least in part on the SRI value being a fourth value of the plurality of values.

9. The UE of claim 1, wherein the one or more processors are further configured to receive downlink control information (DCI) indicating a code division multiplexing (CDM) group associated with the first uplink repetition component and the second uplink repetition component, wherein the first uplink transmission and the second uplink transmission are frequency division multiplexed.

10. The UE of claim 9, wherein the first uplink repetition component corresponds to a first frequency allocation, and wherein the second uplink repetition component corresponds to a second frequency allocation that is different from the first frequency allocation.

11. The UE of claim 10, wherein the first frequency allocation corresponds to a first half of a plurality of resource blocks, and wherein the second frequency allocation corresponds to a second half of the plurality of resource blocks.

12. The UE of claim 11, wherein the first half of the plurality of resource blocks is associated with a first codeword corresponding to a transport block, and wherein the second half of the plurality of resource blocks is associated with a second codeword corresponding to the transport block.

13. The UE of claim 12, wherein the first codeword is the second codeword.

14. The UE of claim 11, wherein first half of the plurality of resource blocks comprises a set of resource blocks with even resource block IDs, and wherein the second half of the plurality of resource blocks comprises a set of resource blocks with odd resource block IDs.

15. The UE of claim 1, wherein the one or more processors are further configured to receive a radio resource control (RRC) message indicating at least one sounding reference signal (SRS) resource indicator (SRI) associated with the first uplink repetition component and the second uplink repetition component, wherein the first uplink transmission and the second uplink transmission are multiplexed based on at least one of frequency division multiplexing or spatial division multiplexing.

16. The UE of claim 15, wherein a first SRS resource set of a plurality of SRS resource sets is associated with the first uplink repetition component and the second uplink repetition component based at least in part on the at least one SRI comprising only one SRI.

17. The UE of claim 15, wherein a first SRS resource set of a plurality of SRS resource sets is associated with the first uplink repetition component and a second SRS resource set of the plurality of SRS resource sets based at least in part on the at least one SRI comprising a first SRI associated with the first SRS resource set and a second SRI associated with the second SRS resource set.

18. The UE of claim 1, wherein the first mapping comprises a direct mapping between the first TRP ID and the first uplink repetition component, and wherein the second mapping comprises a direct mapping between the second TRP ID and the second uplink repetition component.

19. The UE of claim 18, wherein a beam indicator indicates a number of uplink beams associated with the first uplink repetition component and the second uplink repetition component.

20. The UE of claim 18, wherein the first uplink transmission and the second uplink transmission are time division multiplexed.

21. The UE of claim 1, wherein the first uplink repetition component comprises a first uplink control channel component and the second uplink repetition component comprises a second uplink control channel component, and wherein the first uplink transmission and the second uplink transmission are multiplexed using at least one of spatial division multiplexing or frequency division multiplexing, and wherein the one or more processors are further configured to:
transmit a first uplink shared channel transmission corresponding to a first uplink shared channel component; and
transmit a second uplink shared channel transmission corresponding to a second uplink shared channel component.

22. The UE of claim 21, wherein the first uplink shared channel component corresponds to a first frequency allocation, and wherein the second uplink shared channel component corresponds to a second frequency allocation that is different from the first frequency allocation.

23. The UE of claim 22, wherein the first frequency allocation corresponds to a first half of a plurality of resource blocks, and wherein the second frequency allocation corresponds to a second half of the plurality of resource blocks.

24. The UE of claim 23, wherein first half of the plurality of resource blocks comprises a set of resource blocks with even resource block IDs, and wherein the second half of the plurality of resource blocks comprises a set of resource blocks with odd resource block IDs.

25. A network node for wireless communication, comprising:
a memory; and
one or more processors, coupled to the memory, configured to:
transmit an uplink repetition configuration comprising a first mapping between a first transmit-receive point (TRP) identifier (ID) and a first uplink repetition component and a second mapping between a second TRP ID and a second uplink repetition component;
receive a first uplink transmission corresponding to the first TRP ID based at least in part on the first mapping; and
receive a second uplink transmission corresponding to the second TRP ID based at least in part on the second mapping.

26. The network node of claim 25, wherein the first uplink transmission and the second uplink transmission are simultaneous uplink transmissions.

27. A method of wireless communication performed by a user equipment (UE), comprising:
receiving, from a network node associated with a first transmit-receive point (TRP) identifier (ID) and a second TRP ID, an uplink repetition configuration comprising a first mapping between the first TRP ID and a first uplink repetition component and a second mapping between the second TRP ID and a second uplink repetition component;
transmitting a first uplink transmission corresponding to the first TRP ID based at least in part on the first mapping; and
transmitting a second uplink transmission corresponding to the second TRP ID based at least in part on the second mapping.

28. The method of claim 27, wherein the first uplink transmission and the second uplink transmission are simultaneous uplink transmissions.

29. A method of wireless communication performed by a network node, comprising:
transmitting an uplink repetition configuration comprising a first mapping between a first transmit-receive point (TRP) identifier (ID) and a first uplink repetition component and a second mapping between a second TRP ID and a second uplink repetition component;
receiving a first uplink transmission corresponding to the first TRP ID based at least in part on the first mapping; and
receiving a second uplink transmission corresponding to the second TRP ID based at least in part on the second mapping.

30. The method of claim 29, wherein the first uplink transmission and the second uplink transmission are simultaneous uplink transmissions.
